(19) United States
(12) Patent Application Publication
(10) Pub. No.: US 2026/0286975 A1
(43) Pub. Date: Sep. 24, 2026

(54) AIR TREATMENT DEVICE

(71) Applicant: SHENZHEN CHENBEI TECHNOLOGY CO., LTD., SHENZHEN (CN)

(72) Inventors: Yu TANG, SHENZHEN (CN); Donghai LIU, SHENZHEN (CN); Wenchao SUN, SHENZHEN (CN); Bo WANG, SHENZHEN (CN)

(73) Assignee: SHENZHEN CHENBEI TECHNOLOGY CO., LTD., SHENZHEN (CN)

(21) Appl. No.: 19/530,418

(22) Filed: Feb. 5, 2026

(30) Foreign Application Priority Data
Mar. 24, 2025 (CN) 202520537422.6

(51) Int. Cl. F04D 29/44; F04D 17/08; F04D 29/28

(52) U.S. Cl. CPC F04D 29/441; F04D 17/08; F04D 29/281

(57) ABSTRACT

An air treatment device includes a mounting plate and an air guide shroud. The mounting plate is provided with a mounting portion. The air guide shroud includes an arcuate plate, a first air guide plate and a second air guide plate. The arcuate plate surrounds the mounting portion and is disposed on the mounting plate. The first air guide plate is connected to one end of the arcuate plate, the second air guide plate is connected to the other end of the arcuate plate, and an air guide channel is formed between the first air guide plate and the second air guide plate. Along an air guiding direction of the air guide channel, the second air guide plate extends away from the first air guide plate. An arc-shaped air guide portion is disposed between the arcuate plate and the second air guide plate.

### CROSS REFERENCE TO THE RELATED APPLICATIONS

This application is based upon and claims priority to Chinese Patent Application No. 202520537422.6, filed on Mar. 24, 2025, the entire contents of which are incorporated herein by reference.

### TECHNICAL FIELD

The present disclosure relates to the technical field of household appliances, and in particular to an air treatment device.

### BACKGROUND

In the related art, forward-inclined centrifugal fans available on the existing market generally exhibit high-frequency whistling noise. For example, due to improper design of air guide channels, such centrifugal fans are prone to generating excessive noise, and particularly, their sound intensity can easily reach 48 dB or higher. During use, the excessive noise makes users uncomfortable, and may even severely impair users' sleep quality.

### SUMMARY

The present disclosure aims to solve at least one of the technical problems existing in the prior art. In view of this, the present disclosure provides an air treatment device. The air treatment device can effectively reduce noise generated when airflow enters an air guide channel.

According to a first aspect, an embodiment of the present disclosure provides an air treatment device, including:

a mounting plate, provided with a mounting portion where an impeller is mounted; and

an air guide shroud, including an arcuate plate, a first air guide plate and a second air guide plate that are connected, where the arcuate plate is disposed on the mounting plate and at a peripheral side of the impeller; the first air guide plate is connected to one end of the arcuate plate; the second air guide plate is connected to the other end of the arcuate plate; and an air guide channel is formed between the first air guide plate and the second air guide plate; and

the second air guide plate extends away from the first air guide plate; an arc-shaped air guide portion is disposed between the arcuate plate and the second air guide plate; and a radius of an outer arc surface of the air guide portion ranges from 14 mm to 20 mm.

According to some embodiments of the present disclosure, an outer radius of the air guide portion is 16 mm.

According to some embodiments of the present disclosure, a line from at least one position of the outer arc surface of the air guide portion to a center point of the impeller is defined as a first reference line; a line passing through a center point of the arcuate plate and upward relative to the air treatment device is defined as a second reference line; and an included angle between the first reference line and the second reference line ranges from 5° to 15°.

According to some embodiments of the present disclosure, the air guide portion has a guiding arc surface facing the air guide channel, and the first reference line is tangent to the guiding arc surface.

According to some embodiments of the present disclosure, the impeller is a centrifugal impeller; the centrifugal impeller includes a circular end cover and a plurality of centrifugal blades; the plurality of centrifugal blades are arranged in sequence around the circular end cover; an air outlet channel is formed between adjacent centrifugal blades; and along a radial direction of the circular end cover, the centrifugal blade is arranged in an arc shape.

According to some embodiments of the present disclosure, an end of an inner arc surface of the centrifugal blade adjacent to a connecting portion is an air inlet end; a tangent line of the air inlet end is defined as a third reference line; a line passing through the air inlet end and a center point of the circular end cover is defined as a fourth reference line; and an included angle between the third reference line and the fourth reference line ranges from 0° to 10°.

According to some embodiments of the present disclosure, the included angle between the third reference line and the fourth reference line ranges from 3° to 8°.

According to some embodiments of the present disclosure, an end of an inner arc surface of the centrifugal blade away from a connecting portion is an air outlet end; a tangent line of the air outlet end is defined as a fifth reference line; a line passing through the air outlet end and a center point of the circular end cover is defined as a sixth reference line; and an included angle between the fifth reference line and the sixth reference line ranges from 110° to 115°.

According to some embodiments of the present disclosure, there are 48 to 55 centrifugal blades, and an inner diameter of the centrifugal blade ranges from 27 mm to 33 mm.

According to some embodiments of the present disclosure, an air-guiding inclined surface or an air-guiding arc surface is disposed between an end of the centrifugal blade away from a connecting portion and an outer arc surface of the centrifugal blade, and the circular end cover is provided with openings around the connecting portion.

As can be seen from the above technical solutions, the embodiment of the present disclosure has the following advantages: When the air treatment device is used, a motor is disposed on the mounting portion. The centrifugal impeller is disposed inside the air guide shroud, and connected to a drive shaft of the motor. The motor drives the centrifugal impeller to rotate circumferentially, and outside air flows to the arcuate plate from air inlets. Under the action of the centrifugal impeller, the airflow enters the air guide channel. Along an air guiding direction of the air guide channel, the second air guide plate extends away from the first air guide plate. Therefore, after the airflow enters the air guide channel, the airflow diffuses under the guidance of the second air guide plate. Moreover, the arc-shaped air guide portion is disposed between the arcuate plate and the second air guide plate, and the inner radius of the air guide portion ranges from 14 mm to 20 mm. Through test, the air guide portion has an appropriate size, that is, the size of the air guide portion is neither too large nor too small. Therefore, the airflow can smoothly enter the air guide channel, and diffuse along an extension direction of the second air guide plate, thereby reducing significant noise when the airflow passes through the air guide portion.

### BRIEF DESCRIPTION OF THE DRAWINGS

FIG. 1 is an overall schematic structural view of a fan assembly according to an embodiment of the present disclosure;

FIG. 2 is a schematic exploded view of a fan assembly according to an embodiment of the present disclosure;

FIG. 3 is a front view of a fan assembly according to an embodiment of the present disclosure;

FIG. 4 is a schematic structural view of a centrifugal impeller according to an embodiment of the present disclosure;

FIG. 5 is an overall schematic structural view of an air treatment device according to an embodiment of the present disclosure;

FIG. 6 is a schematic diagram of an improved noise state of an air treatment device; and

FIG. 7 is a schematic diagram of an unimproved noise state of an air treatment device.

### REFERENCE NUMERALS

100: air treatment device, 110: mounting plate, 111: air inlet, 112: mounting portion, 120: air guide shroud, 121: first air guide plate, 122: second air guide plate, 123: arcuate plate, 124: air guide channel, 125: air guide portion, 1251: guiding arc surface, 140: first reference line, 150: second reference line, 200: motor, 300: centrifugal impeller, 310: circular end cover, 311: opening, 312: connecting portion, 320: centrifugal blade, 321: air inlet end, 322: air outlet end, 323: air-guiding arc surface, 330: third reference line, 340: fourth reference line, 350: fifth reference line, 360: sixth reference line, and 370: annular frame.

### DETAILED DESCRIPTION OF THE EMBODIMENTS

The embodiments of the present disclosure are described below in detail. Examples of the embodiments are shown in the accompanying drawings. The same or similar numerals represent the same or similar elements or elements having the same or similar functions throughout the specification. The embodiments described below with reference to the accompanying drawings are exemplary, are used only for explaining the present disclosure, and should not be construed as a limitation to the present disclosure.

In the description of the present disclosure, it should be understood that orientation or position relationships indicated by terms "upper", "lower", "front", "rear", "top", "bottom", and the like are orientation or position relationships as shown in the accompanying drawings, and these terms are just used to facilitate description of the present disclosure and simplify the description, but not to indicate or imply that the mentioned apparatus or element must have a specific orientation and must be constructed and operated in a specific orientation, and thus cannot be construed as a limitation to the present disclosure.

In the description of the present disclosure, "several" means one or more, "a plurality of" means two or more, "greater than", "less than", "over" and the like are construed as excluding the number, and "above", "below", "within" and the like are construed as including the number. The "first" and "second" in the description are merely intended to distinguish technical features, rather than to indicate or imply relative importance or implicitly indicate a number of the indicated technical features or implicitly indicate a sequence relationship of the indicated technical features.

In the description of the present disclosure, unless otherwise explicitly defined, the words such as "arrange", "mount" and "connect" should be understood in a broad sense, and those skilled in the art can reasonably determine the specific meanings of the above words in the present disclosure with reference to specific contents of the technical solutions.

In the description of this specification, the description with reference to the terms "an embodiment", "some embodiments", "an illustrative embodiment", "an example", "a specific example", or "some examples" means that specific features, structures, materials or characteristics described with reference to the embodiment or example are included in at least one embodiment or example of the present disclosure. In this specification, the schematic representations of the above terms do not necessarily refer to the same embodiment or example. In addition, the specific features, structures, materials, or characteristics described may be combined in any suitable manner in any one or more embodiments or examples.

The present disclosure is further described below with reference to the accompanying drawings.

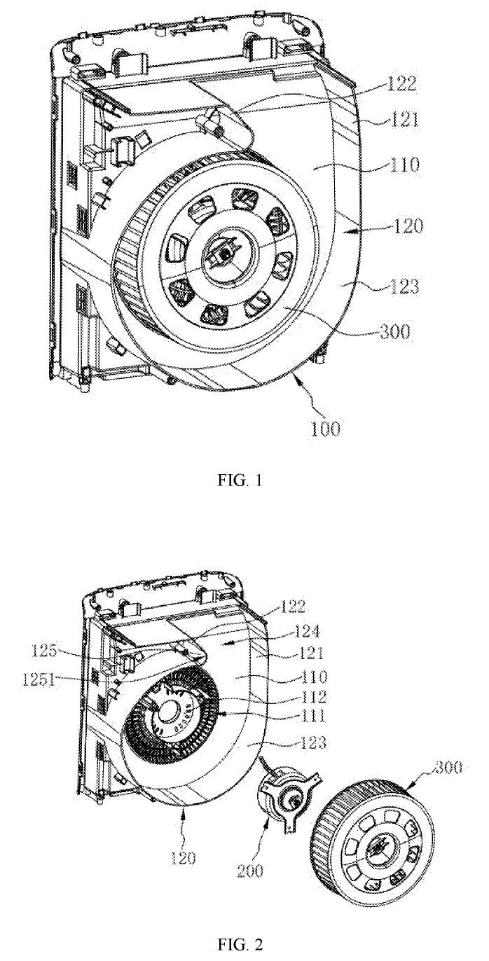

Referring to FIGS. 1-3, an embodiment of the present disclosure provides the air treatment device 100, including the mounting plate 110 and the air guide shroud 120. The mounting plate 110 is provided with the mounting portion 112 where an impeller is mounted. More exactly, the motor 200 corresponding to the impeller is mounted on the mounting portion 112. The mounting plate 110 is provided with the air inlets 111 around the mounting portion 112. The air guide shroud 120 includes the arcuate plate 123, the first air guide plate 121, and the second air guide plate 122 that are connected. The arcuate plate 123 surrounds the mounting portion 112 and is disposed on the mounting plate 110, that is, the arcuate plate 123 is disposed at a peripheral side of the impeller. The first air guide plate 121 is connected to one end of the arcuate plate 123. The second air guide plate 122 is connected to the other end of the arcuate plate 123. The air guide channel 124 is formed between the first air guide plate 121 and the second air guide plate 122. Along an air guiding direction of the air guide channel 124, the second air guide plate 122 extends away from the first air guide plate 121. The arc-shaped air guide portion 125 is disposed between the arcuate plate 123 and the second air guide plate 122. The radius R1 of an outer arc surface of the air guide portion 125 ranges from 14 mm to 20 mm (referring to FIG. 3). The outer arc surface of the air guide portion 125 is an arc-shaped transition structure between the arcuate plate 123 and the second air guide plate 122. Airflow smoothly transitions from the arcuate plate to the second air guide plate. The airflow passes through the arcuate plate, the outer arc surface of the air guide portion, and the second air guide plate. The radius R1 of the outer arc surface of the air guide portion 125 may also be referred to as the outer radius R1 or the inner radius R1 of the air guide portion 125.

Specifically, when the air treatment device 100 is used, the motor 200 corresponding to the impeller is disposed on the mounting portion 112. The centrifugal impeller 300 of the impeller is disposed inside the air guide shroud 120, and connected to a drive shaft of the motor 200. The motor 200 drives the centrifugal impeller 300 to rotate circumferentially, and the outside air flows to the arcuate plate 123 from the air inlets 111. Under the action of the centrifugal impeller 300, the airflow enters the air guide channel 124. Since the second air guide plate 122 extends away from the first air guide plate 121 along the air guiding direction of the air guide channel 124, after the airflow enters the air guide channel 124, the airflow diffuses under the guidance of the second air guide plate 122.

The arcuate plate 123, the first air guide plate 121, and the second air guide plate 122 are integrally formed, which eliminates seams caused by conventional splicing or welding, prevents air leakage or structural deformation resulting from weak joints, enhances overall rigidity, and reduces vibration and noise during the high-speed rotation of the impeller. This also improves the airtightness for the airflow in the air guide channel, reduces turbulent energy loss, and enhances aerodynamic efficiency.

The arc-shaped air guide portion 125 is disposed between the arcuate plate 123 and the second air guide plate 122, and the inner radius R1 of the air guide portion 125 ranges from 14 mm to 20 mm. For example, the inner radius R1 of the air guide portion 125 ranges from 15 mm to 17 mm. Alternatively, the inner radius R1 of the air guide portion 125 is 14 mm, 15 mm, 16 mm, 17 mm, 18 mm, 19 mm, and 20mm. Through test, the air guide portion 125 has an appropriate size, that is, the size of the air guide portion 125 is neither too large nor too small. Therefore, the airflow can smoothly enter the air guide channel 124, and diffuse outward along an extension direction of the second air guide plate 122, thereby reducing significant noise when the airflow passes through the air guide portion 125. With the specific size for the radius of the outer arc surface of the air guide portion, the high-speed airflow output by the impeller smoothly transitions from the arcuate plate to the second air guide plate, thereby preventing turbulence or separation of the airflow caused by abrupt direction change, reducing the impact friction between the airflow and the wall surface, lowering energy loss, ensuring uniform diffusion of the airflow along the extension direction of the second air guide plate, and improving the uniformity of the outlet air volume. The outer arc surface of the air guide portion optimizes an air-out pressure gradient. Through an arc curvature of the radius of the specific outer arc surface, a flow velocity distribution of the airflow on the surface of the air guide portion is controlled, and a divergent flow channel is formed. For example, high-pressure kinetic energy at an outlet of the impeller is gradually converted into static pressure energy, improving the overall static pressure efficiency of the device, suppressing non-uniform diffusion of the airflow caused by a centrifugal force, and preventing local vortices. Meanwhile, the arc-shaped air guide portion eliminates the airflow separation phenomenon at right angles or acute angles, reducing high-frequency turbulent noise sources.

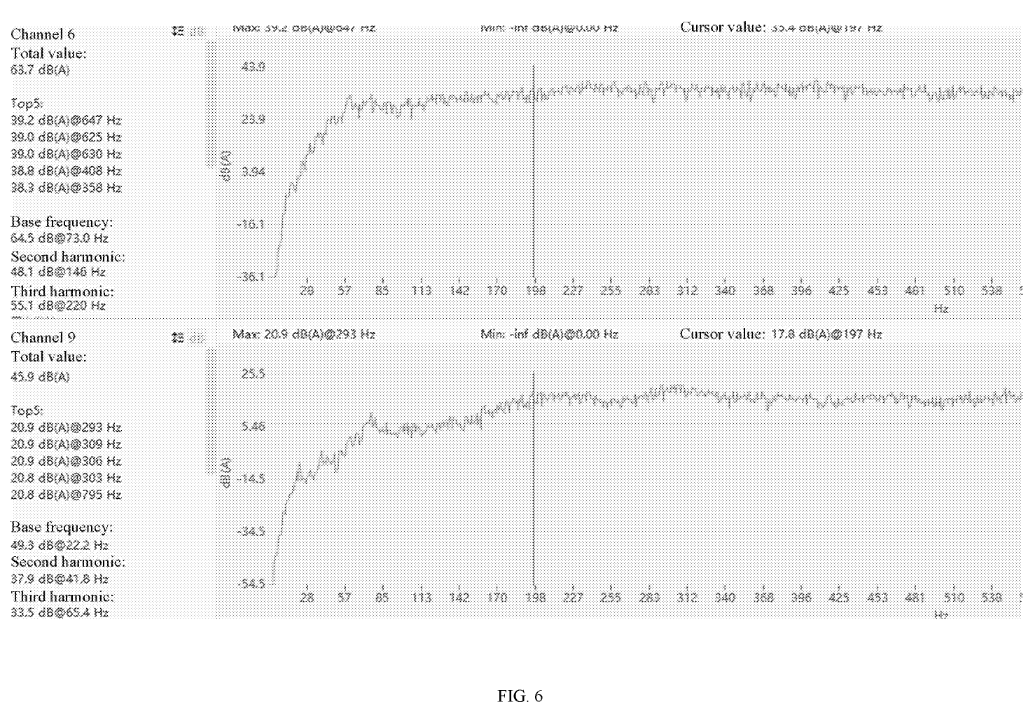

As shown by FIG. 6, the test is conducted in a silent space environment where the background noise/ambient noise is 16 dB. When the air treatment device 100 is used, the decibel level detected by a monitoring device remains relatively stable, and no abnormal and excessively high decibel levels appear. For example, no abnormal noise exceeding 40 dB appears, indicating that the air treatment device has desirable use experience.

Further, an outer radius of the air guide portion is 16 mm. More exactly, the radius of the outer arc surface of the air guide portion 125 facing the air guide channel 124 is 16 mm. This further reduces the significant noise generated when the airflow passes through the air guide portion 125.

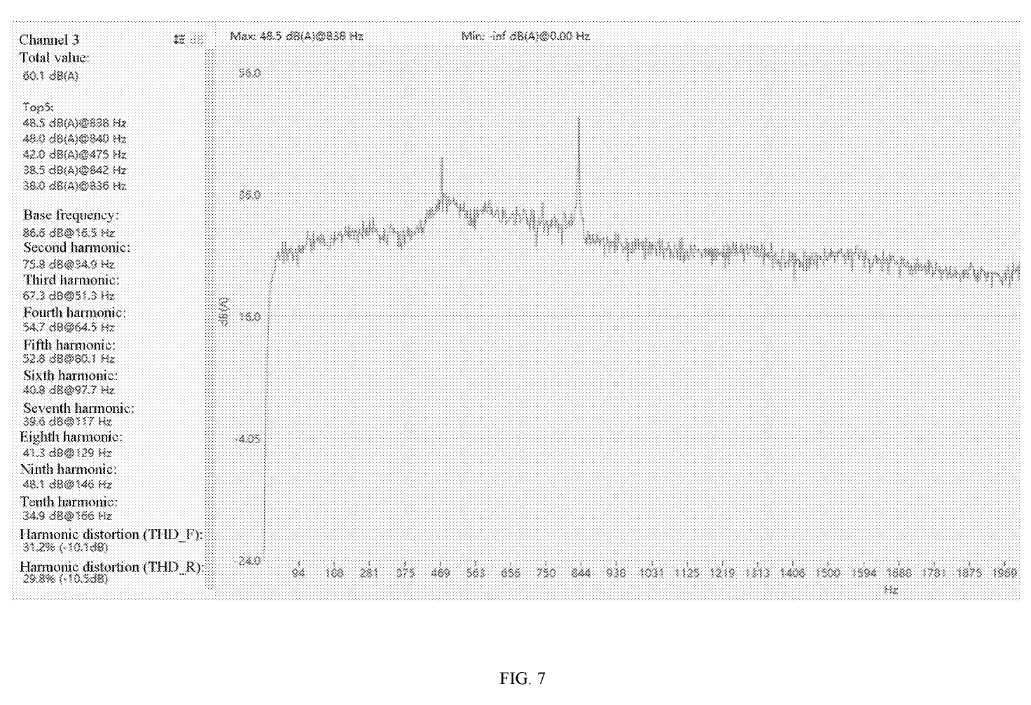

As shown by FIG. 7, when the outer radius of the air guide portion is 7 mm, under the same test conditions, whistling noise caused by air ducts of the blades obviously exists during high-speed operation of the impeller, with a peak at a frequency of 850 Hz and a sound intensity of 48 dB. Additionally, the comprehensive noise is relatively high, reaching 53.8 dB.

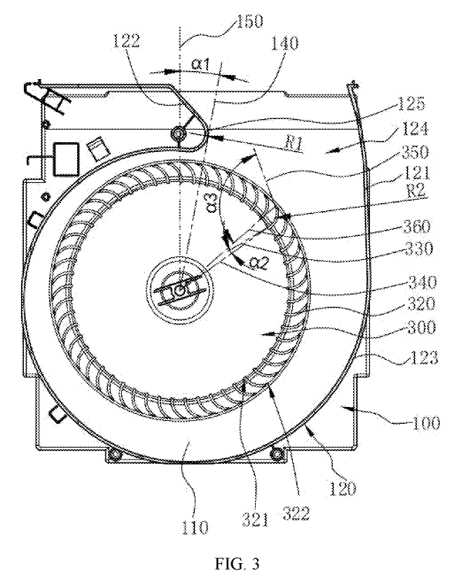

In some embodiments, referring to FIGS. 2-3, a line from at least one position of the outer arc surface of the air guide portion 125 to a center point of the arcuate plate 123 is defined as the first reference line 140. A line passing through the center point of the arcuate plate 123 and approximately consistent with an orientation of an opening of the air guide channel 124 is defined as the second reference line 150. More exactly, a line passing through the center point of the arcuate plate and upward relative to the air treatment device is defined as the second reference line. For example, the air treatment device 100 is in a vertical state in use, and an air outlet of the air guide channel 124 is approximately upward. Accordingly, the second reference line 150 is an extension line that is connected to a center point of the centrifugal impeller 300 and vertically upward. The included angle α1 between the first reference line 140 and the second reference line 150 ranges from 5° to 15°. For example, the included angle α1 is 5°, 7°, 10°, 13°, or 15°.

It is to be understood that the included angle α1 of 5° to 15° between the first reference line 140 and the second reference line 150 ensures an appropriate spacing between the air guide portion 125 and the first air guide plate 121, allowing the airflow to smoothly enter the air guide channel 124, and diffuse along the second air guide plate 122. Meanwhile, the above angle further ensures that no significant noise is generated when the airflow passes through the air guide portion 125.

Further, referring to FIGS. 2-3, the air guide portion 125 has a guiding arc surface facing the air guide channel 124. The first reference line 140 is tangent to the guiding arc surface 1251. This further limits a position of the air guide portion 125 to ensure the appropriate spacing between the air guide portion 125 and the first air guide plate 121, allowing the airflow to smoothly enter the air guide channel 124, and diffuse along the second air guide plate 122. Meanwhile, the above angle further ensures that no significant noise is generated when the airflow passes through the air guide portion 125.

In some embodiments, the impeller is the centrifugal impeller 300. The motor 200 is connected to the centrifugal impeller 300 that is disposed within the arcuate plate 123. Specifically, the motor 200 is disposed on the mounting portion 112. The drive shaft of the motor 200 extends along a central shaft of the arcuate plate 123. The centrifugal impeller 300 includes the circular end cover 310, a plurality of centrifugal blades 320, and the annular frame 370. The circular end cover 310 is disposed inside the arcuate plate 123, and spaced apart from the mounting plate 110. The connecting portion 312 is disposed at the center of the circular end cover 310. The drive shaft of the motor 200 is connected to the connecting portion 312. The annular frame 370 is located at a side of the circular end cover 310 adjacent to the mounting plate 110, and disposed opposite to an edge of the circular end cover 310. The plurality of centrifugal blades 320 are arranged in sequence around the circular end cover 310. The plurality of centrifugal blades 320 extend to the mounting plate 110, and are connected to the annular frame 370. An air outlet channel is formed between adjacent centrifugal blades 320. Hence, the motor 200 drives the circular end cover 310 to rotate around its central shaft, thereby driving each centrifugal blade 320 to rotate circumferentially.

In specific use, the motor 200 drives the centrifugal blades 320 to rotate circumferentially. The airflow from the air inlets 111 flows from the air outlet channels to the air guide channel 124 under the action of the centrifugal impeller 300, and thus is delivered to a desired position. It is to be understood that the centrifugal impeller 300 of this structural form cooperates with the air treatment device 100 of the above structural form in use, such that the generated airflow can be effectively guided to the desired position, and noise generated by the airflow in the flowing process can be reduced.

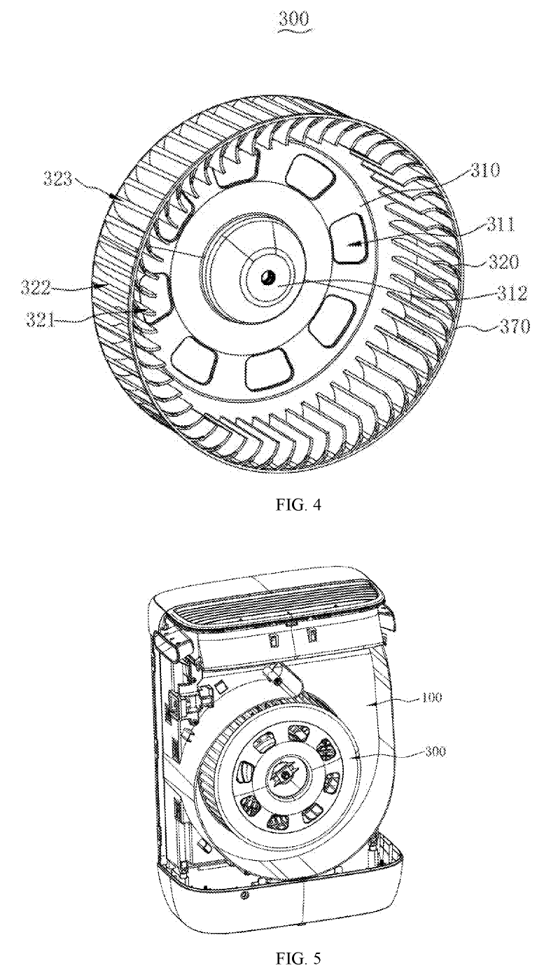

In some embodiments, referring to FIGS. 3-4, along a radial direction of the circular end cover 310, the centrifugal blade 320 is arranged in an arc shape. The air outlet channels are formed between inner arc surfaces and outer arc surfaces of adjacent centrifugal blades. An end of an inner arc surface of the centrifugal blade adjacent to the connecting portion 312 is the air inlet end 321. A tangent line of the air inlet end 321 is defined as the third reference line 330. A line passing through the air inlet end 321 and a center point of the circular end cover 310 is defined as the fourth reference line 340. The included angle α2 between the third reference line 330 and the fourth reference line 340 ranges from 0° to 10°. For example, the included angle α2 is 1°, 3°, 5°, 7°, 8°, or 10°. It is to be understood that through test with the above size of the centrifugal blade, when the airflow flows to the air outlet channels, the airflow can smoothly enter the air outlet channels, and the significant noise can be reduced.

Further, the included angle between the third reference line and the fourth reference line ranges from 3° to 8°. For example, the included angle α2 is 3°, 5°, 7°, or 8°. It is to be understood that through test with the above size of the centrifugal blade, when the airflow flows to the air outlet channels, the airflow can smoothly enter the air outlet channels, the significant noise can be reduced, and particularly the abnormal noise greater than 40 dB can be effectively prevented.

In some embodiments, referring to FIGS. 3-4, along the radial direction of the circular end cover 310, the centrifugal blades 320 are arranged in the arc shape. An end of an inner arc surface of the plurality of centrifugal blades away from the connecting portion 312 is the air outlet end 322. A tangent line of the air outlet end 322 is defined as the fifth reference line 350. A line passing through the air outlet end 322 and a center point of the circular end cover 310 is defined as the sixth reference line 360. The included angle α3 between the fifth reference line 350 and the sixth reference line 360 ranges from 110° to 115°. For example, the included angle α3 is 110°, 111°, 112°, 113°, 114°, or 115°. It is to be understood that through test with the above size of the centrifugal blade, when the airflow flows out from the air outlet channels, the airflow can smoothly enter the air guide channel 124, and the significant noise can be reduced.

Further, there are 48 to 55 centrifugal blades 320. The inner diameter R2 of the centrifugal blade 320 ranges from 27 mm to 33 mm. For example, the inner diameter R2 is 27 mm, 29 mm, 31 mm, or 33 mm. It is to be understood that through test with the above number of the centrifugal blades 320 and the above inner diameters of the centrifugal blades 320, the airflow can smoothly flow out along the air outlet channels, and the significant noise can be reduced.

In some embodiments, referring to FIGS. 3-4, the air-guiding inclined surface or air-guiding arc surface 323 is disposed between an end of each centrifugal blade 320 away from the connecting portion 312 and an outer arc surface of the centrifugal blade 320. In this way, when the airflow flows out from the air outlet channels, the airflow tends to move circumferentially. Hence, a tail end of the centrifugal blade 320 in reverse directions of the air outlet channels may affect the flowing of the airflow. The tail end of the centrifugal blade 320 is provided with the air-guiding inclined surface or air-guiding arc surface 323, which can effectively guide the airflow to the air guide channel 124, reducing the large noise generated when the airflow flows out from the air outlet channels.

In some embodiments, referring to FIGS. 3-4, the circular end cover 310 is provided with the openings 311 around the connecting portion 312. In this way, the weight of the centrifugal impeller 300 is effectively reduced, thereby saving energy consumption of the motor 200. Meanwhile, the openings 311 in the circular end cover 310 can also provide airflow for the centrifugal impeller 300, such that the centrifugal impeller 300 achieves desirable operation efficiency.

The present disclosure provides an air treatment device. Referring to FIGS. 3-5, the air treatment device includes a fan assembly. For example, the fan assembly is vertically disposed in a body of the air treatment device. An air outlet of the air guide channel 124 is upward.

It is to be understood that the air treatment device uses the fan assembly, and the fan assembly uses the above air treatment device 100. In specific use, the motor 200 drives the centrifugal blades 320 to rotate circumferentially. The airflow from the air inlets 111 flows from the air outlet channels to the air guide channel 124 under the action of the centrifugal impeller 300, and thus is delivered to an upward position. It is to be understood that the centrifugal impeller 300 of this structural form cooperates with the air treatment device 100 of the above structural form in use, such that the generated airflow can be effectively guided to the desired position, and noise generated by the airflow in the flowing process can be reduced. The air treatment device has desirable use experience.

The technical means disclosed in the solution of the present disclosure is not limited to those disclosed in the above implementations, but also includes a technical solution composed of any combination of the above technical features. It should be noted that those of ordinary skill in the art may further make several improvements and modifications without departing from the principle of the present disclosure, but such improvements and modifications should be deemed as falling within the protection scope of the present disclosure.

1. An air treatment device, comprising:
a mounting plate, provided with a mounting portion where an impeller is mounted; and
an air guide shroud, comprising an arcuate plate, a first air guide plate and a second air guide plate, wherein the arcuate plate, the first air guide plate and the second air guide plate are connected; the arcuate plate is disposed on the mounting plate and at a peripheral side of the impeller; the first air guide plate is connected to a first end of the arcuate plate; the second air guide plate is connected to a second end of the arcuate plate; and an air guide channel is formed between the first air guide plate and the second air guide plate;
wherein the second air guide plate extends away from the first air guide plate; an arc-shaped air guide portion is disposed between the arcuate plate and the second air guide plate; and a radius of an outer arc surface of the arc-shaped air guide portion ranges from 14 mm to 20 mm.

2. The air treatment device according to claim 1, wherein the radius of the outer arc surface of the arc-shaped air guide portion is 16 mm.

3. The air treatment device according to claim 1, wherein a line from at least one position of the outer arc surface of the arc-shaped air guide portion to a center point of the impeller is defined as a first reference line; a line passing through a center point of the arcuate plate and upward relative to the air treatment device is defined as a second reference line; and an included angle between the first reference line and the second reference line ranges from 5° to 15°.

4. The air treatment device according to claim 3, wherein the arc-shaped air guide portion has a guiding arc surface facing the air guide channel, and the first reference line is tangent to the guiding arc surface.

5. The air treatment device according to claim 1, wherein the impeller is a centrifugal impeller; the centrifugal impeller comprises a circular end cover and a plurality of centrifugal blades; the plurality of centrifugal blades are arranged in sequence around the circular end cover; an air outlet channel is formed between adjacent centrifugal blades of the plurality of centrifugal blades; and along a radial direction of the circular end cover, each of the plurality of centrifugal blades is arranged in an arc shape.

6. The air treatment device according to claim 5, wherein an end of an inner arc surface of each of the plurality of centrifugal blades adjacent to a connecting portion is an air inlet end; a tangent line of the air inlet end is defined as a third reference line; a line passing through the air inlet end and a center point of the circular end cover is defined as a fourth reference line; and an included angle between the third reference line and the fourth reference line ranges from 0° to 10°.

7. The air treatment device according to claim 6, wherein the included angle between the third reference line and the fourth reference line ranges from 3° to 8°.

8. The air treatment device according to claim 5, wherein an end of an inner arc surface of each of the plurality of centrifugal blades away from a connecting portion is an air outlet end; a tangent line of the air outlet end is defined as a fifth reference line; a line passing through the air outlet end and a center point of the circular end cover is defined as a sixth reference line; and an included angle between the fifth reference line and the sixth reference line ranges from 110° to 115°.

9. The air treatment device according to claim 5, wherein the plurality of centrifugal blades comprise 48 to 55 centrifugal blades, and an inner diameter of each of the plurality of centrifugal blades ranges from 27 mm to 33 mm.

10. The air treatment device according to claim 5, wherein an air-guiding inclined surface or an air-guiding arc surface is disposed between an end of each of the plurality of centrifugal blades away from a connecting portion and an outer arc surface of each of the plurality of centrifugal blades, and the circular end cover is provided with openings around the connecting portion.
